(19) United States
(12) Patent Application Publication
(10) Pub. No.: US 2021/0296971 A1
(43) Pub. Date: Sep. 23, 2021

(54) FORMING SLOTS IN MAGNETIC STEEL LAMINATES IN ELECTROMAGNETIC TRANSDUCERS AND APPLICATION IN VEHICLES

(71) Applicants: Michael Frank, Blankenfelde-Mahlow (DE); Marc Lessmann, Blankenfelde-Mahlow (DE); Matthias Kowalski, Blankenfelde-Mahlow (DE); Carina Kowalski, Blankenfelde-Mahlow (DE); Markus Wilke, Blankenfelde-Mahlow (DE); Jörn Grundmann, Blankenfelde-Mahlow (DE); Lars Kühn, Blankenfelde-Mahlow (DE)

(72) Inventors: Michael Frank, Blankenfelde-Mahlow (DE); Marc Lessmann, Blankenfelde-Mahlow (DE); Matthias Kowalski, Blankenfelde-Mahlow (DE); Carina Kowalski, Blankenfelde-Mahlow (DE); Markus Wilke, Blankenfelde-Mahlow (DE); Jörn Grundmann, Blankenfelde-Mahlow (DE); Lars Kühn, Blankenfelde-Mahlow (DE)

(21) Appl. No.: 17/198,237

(22) Filed: Mar. 10, 2021

(30) Foreign Application Priority Data
Mar. 17, 2020 (DE) 10 2020 203 403.6

(51) Int. Cl. H02K 15/03; H02K 15/02; H02K 15/10; H02K 1/16; H02K 1/02

(52) U.S. Cl. CPC H02K 15/03; H02K 15/024; H02K 1/02; H02K 1/165; H02K 15/10

(57) ABSTRACT

A magnetic core for an electromagnetic transducer having magnetic steel laminates that are stacked in layers is provided. The magnetic core includes at least one slot that is formed in at least one of the magnetic steel laminates. The at least one slot is free of electrically conductive material. A stator including a magnetic core of this kind, a rotatable electrical machine including a stator of this kind, and a vehicle including an electrical machine of this kind are also provided.

This application claims the benefit of German Patent Application No. DE 10 2020 203 403.6, filed on Mar. 17, 2020, which is hereby incorporated by reference in its entirety.

### FIELD

The present embodiments relate to a magnetic core for an electromagnetic transducer, such as an electrical machine or a transformer, a stator including a magnetic core, a rotatable electrical machine including a stator, and to a vehicle including a rotatable electrical machine.

### BACKGROUND

Heavily utilized electrical machines generally face the problem of increased loss densities in the region of the end faces of the stator yoke. In spite of extensive cooling measures, the associated heating may, in extreme cases, be the limiting factor for the effective power converted in the machine and therefore the achievable power density of the machine. Accordingly, the objective of every machine design is to minimize these losses.

The cause of the increased losses are the leakage fields that increasingly occur in this region of the machine, caused by the rotor and stator end windings. Owing to the change in the leakage fields over time, these leakage fields induce eddy currents in the electrically conductive end face regions of the stator yoke, and these eddy currents in turn result in resistive losses.

In general, these losses are minimized largely by a stacked laminate structure of the stator, where the individual stator laminates are insulated from one another by inserting an electrically non-conductive intermediate layer. The orientation of the laminates is, for example, selected such that magnetic flux and laminate orientation run in parallel. In this case, the formation of eddy current paths over a large area is largely suppressed, and the eddy current losses are accordingly minimized.

These conditions are found in the central region of the machine where flux guidance may take place in the direction of the laminate owing to the planar magnetic flux.

However, other conditions are found in the end face region of the stator. The magnetic flux runs in a three-dimensional manner, for example, so that flux components that run perpendicular to the direction of the laminate and cause correspondingly high eddy current losses are also always present.

Accordingly, the eddy current losses may be reduced in the case of a three-dimensional flux profile only to a very limited extent with a conventional laminate structure. This creates, amongst other things, problems such as: undesired increase in temperature in the machine; accelerated aging process; reduced service life; increased servicing intervals; major technical risk; reduced degree of efficiency; reduced power density; and increased cooling effort.

The prior art provides different variants for solving the problem of the three-dimensional flux profile and the associated increased eddy current losses.

In machines in which there is generally a three-dimensional flux profile (e.g., including in the central portion of the machine), as is the case in transversal flux machines, for example, soft-magnetic composites (SMCs) are widely used. The two-dimensional laminate structure has, for example, a third dimension added via microscopic particles including ferromagnetic material being covered with an electrically insulating layer and then being sintered to form semifinished products. Accordingly, barriers that suppress the formation of eddy current paths are now also present in the third dimension.

The most significant disadvantage of SMCs is poor magnetic properties, saturation induction lying in the range of from 1.0-1.5 T. In comparison to cobalt-iron alloys with a saturation induction of 2.35 T, considerably more material is therefore to be used for achieving comparable machine performances; therefore the objective of maximizing the volumetric and gravimetric power density is not achieved. Further, SMCs are extremely brittle and therefore may be used only to a limited extent in applications that are subject to high mechanical loads.

In the case of generators in the power plant sector, radial stepping of the stator yoke in an end face region is used as standard. As a result, the magnetic flux originally running perpendicular to the laminate orientation is oriented parallel to the laminate orientation; as a result of this, the eddy current losses are greatly reduced.

However, the additional provision of steps results in axial extension of the stator yoke. This is likewise inconsistent with the requirement for maximizing the gravimetric and volumetric power density. Complexity and costs of manufacture of the individual stator laminates are greatly increased as well. These are conventionally produced by stamping processes, where each individual laminate cross section requires a separate stand tool. Accordingly, an additional stamping tool is required for each step.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, both gravimetric and volumetric power density of an electrical machine may be maximized with a minimal amount of design complexity.

One aspect addresses the solution to these problems on the premise of maximizing both the gravimetric and the volumetric power density of the machine with a minimal amount of design complexity. For example, extremely heavily utilized machines, such as superconducting drives, for example, of which end face leakage fields are markedly pronounced owing to the reduced use of flux-conducting, ferromagnetic components benefit from this solution.

The solution to the above problems is provided by slots made in the end region of the magnetic steel laminates of the stator. These slots perform the function of laminating the laminates (e.g., introducing electrically insulating regions). As a result of this, the formation of eddy current paths over a large area is analogously suppressed, and therefore, the eddy current losses are greatly reduced.

In stators, these slots may be positioned on an inner radius since the greatest leakage fluxes are present here; the slots may, however, also be positioned on the outer radius for further loss reduction. Here, the number of slots made along the circumference and the depth to which these slots cut into the magnetic steel laminate are not important for the present embodiments.

Further, the solution is not limited only to ring laminates, but rather, is also possible for ring-segment laminates in which the slots completely pass through or cut through the magnetic steel laminate in the radial direction.

Further, the solution is not limited only to annular magnetic steel laminates, but rather, may be used for any laminate contour and any cross-sectional profile.

The slots are distinguished in that the slots form an electrically non-conductive incision into the laminate. The thickness of the slots is not important, and the slots may also be filled by electrically non-conductive materials within the scope of the present embodiments.

Similarly, the slots do not have to run exclusively in the radial direction, but rather, may also be made tangentially as solid rings or ring segments.

In principle, any topology of slots is covered by the present embodiments (e.g., oblique and non-linear slots too). In one embodiment, the slots are not limited solely to the stator, but rather, may also be transferred to the rotor.

In the case of special machine topologies, such as superconducting machines, for example, it may be the case that flux components occur perpendicular to the laminate orientation not only in the end face region of the machine, but rather, also in the central machine region. Accordingly, the solution is not limited only to the end face region of the machine, but rather, relates to the entire machine circumference.

An optimized embodiment makes provision for the successive magnetic steel laminates with slots to rotate through an arbitrary angle. This has the result that the slots are no longer in alignment, but rather, cover one another. As a result of this, the mechanical stiffness is increased. In addition, the reluctance of the magnetic core in the circumferential direction is improved since the magnetic flux does not have to pass the slots, but rather, may escape through the axially adjoining laminates. The combination of magnetic steel laminates with different slot topologies is possible as well.

In principle, the present embodiments may be applied to any type of electromagnetic energy transducer, but is primarily intended for energy transducers with increased end face leakage fields such as machines with an air gap winding or superconducting machines.

The present embodiments differ from the described prior art by way of the following advantages. Avoiding complex and expensive stepped design of the stator yoke. In particular applications, SMC materials with poor magnetic and mechanical properties may be replaced. The volumetric and gravimetric power densities may be maximized.

The present embodiments include a magnetic core for an electrical machine. The magnetic core includes magnetic steel laminates that are stacked in layers, where at least one slot is formed in at least one of the magnetic steel laminates. The at least one slot is free of electrically conductive material.

A layer may be “a layer of objects above or below another”.

In a development, the at least one slot may be filled with air and/or an electrically insulating material.

In a further refinement, slots may be arranged offset in relation to one another in different layers. In this case, there may be no continuous opening perpendicular to the layers.

In a further refinement, the magnetic steel laminates may be in the form of a circular ring, where the at least one slot is formed in the radial direction, and where the at least one slot may cut through the magnetic steel laminate in the radial direction.

In a development, the at least one slot may be formed in the circumferential direction, where the at least one slot may cut through the magnetic steel laminate in the circumferential direction.

In a development, the magnetic steel laminate has at least one web that is free of the at least one slot.

The present embodiments also include a stator of a rotatable electrical machine including a magnetic core according to the present embodiments.

The present embodiments also include a rotatable electrical machine including a stator according to the present embodiments.

The present embodiments also include a vehicle (e.g., an aircraft) including a rotatable electrical machine according to the present embodiments for an electric or hybrid-electric drive.

In a development, the vehicle includes a power converter that supplies the rotatable electrical machine and a propeller that may be set in rotation by the rotatable electrical machine.

Further, special features and advantages of the present embodiments will become clear from the following explanations of an exemplary embodiment with reference to schematic drawings.

### BRIEF DESCRIPTION OF THE DRAWINGS

FIG. 1A shows one embodiment of a magnetic steel laminate with internal slots;

FIG. 1B shows a further embodiment of a magnetic steel laminate with internal slots;

FIG. 2A shows one embodiment of a magnetic steel laminate with external slots;

FIG. 2B shows one embodiment of a magnetic steel laminate with internal and external slots;

FIG. 3 shows one embodiment of a magnetic steel laminate with continuous slots;

FIG. 4 shows one embodiment of magnetic steel laminates with slots arranged with an offset;

FIG. 5 shows one embodiment of a magnetic steel laminate with slots arranged in the form of a circle;

FIG. 6 shows a further embodiment of a magnetic steel laminate with slots arranged in the form of a circle;

FIG. 7 shows a further embodiment of a magnetic steel laminate with slots arranged in the form of a circle;

FIG. 8 shows a further embodiment of a magnetic steel laminate with slots arranged in the form of a circle;

FIG. 9 shows one embodiment of a magnetic steel laminate with slots arranged in the form of a circle and webs;

FIG. 10 shows a block diagram of one embodiment of an electrical machine; and

FIG. 11 shows one embodiment of an aircraft including an electrical machine.

### DETAILED DESCRIPTION

Electrically insulating slots (e.g., slots) are made in magnetic steel laminates of a magnetic core. The slots may be filled by an electrically insulating material. In annular magnetic steel laminates, the slots may be formed in a radial direction and/or in a tangential direction (e.g., in a circumferential direction) as a ring or ring segments, but may be oriented in an arbitrary manner and have arbitrary curve shapes. In stators of an electrical machine, the slots may be made on an inner radius of a stator yoke, but may also be positioned on an outer radius or arranged in an arbitrary manner. The slots may have different thicknesses and lengths. The slots may run in a linear manner, but may also assume any other shape. The slots may be distributed in an asymmetrical manner. Each individual magnetic steel laminate may have a different slot topology. The individual magnetic steel laminates may be rotated or arranged in an arbitrary manner in relation to one another. The formation of slots may not be limited only to the region of the end faces of a magnetic core, but rather, may be performed over an entire machine length. The formation of slots may pertain to the entire circumference of the machine (e.g., a stator and rotor).

The present embodiments provide, amongst others, the following advantages. In stators, a stepped stator design (e.g., in generators) is avoided, and as a result, the complexity and costs of manufacture may be reduced. Therefore, for example, a single stamping tool may be sufficient for producing the entire stator laminated core. The slots may be uniformly made in the laminates during the stamping process, or subsequently, by manufacturing processes such as lasering or water-jet cutting. As a result of this, each individual laminate may be provided with an individual slot topology. SMCs and corresponding poor magnetic and mechanical properties may be substituted. New fields of activity or existing fields of activity, in which the volumetric and/or gravimetric power density is to be maximized, such as in aerospace engineering, in special machines, or in wind turbines for example, may be created or extended, respectively.

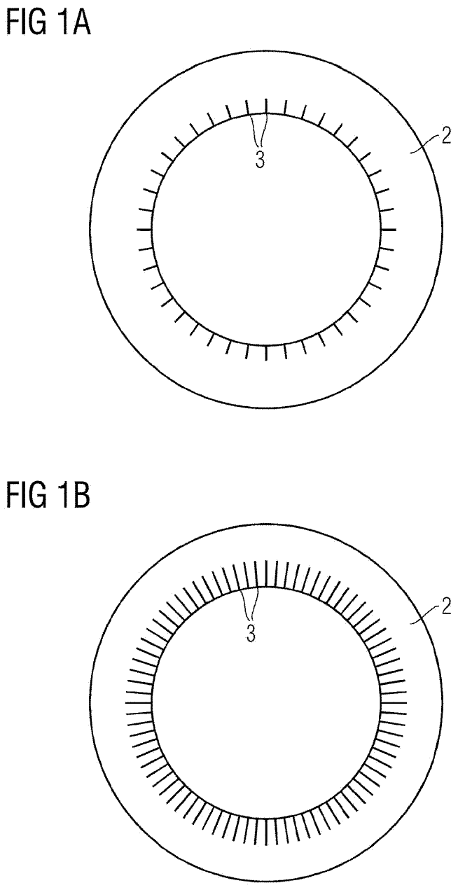

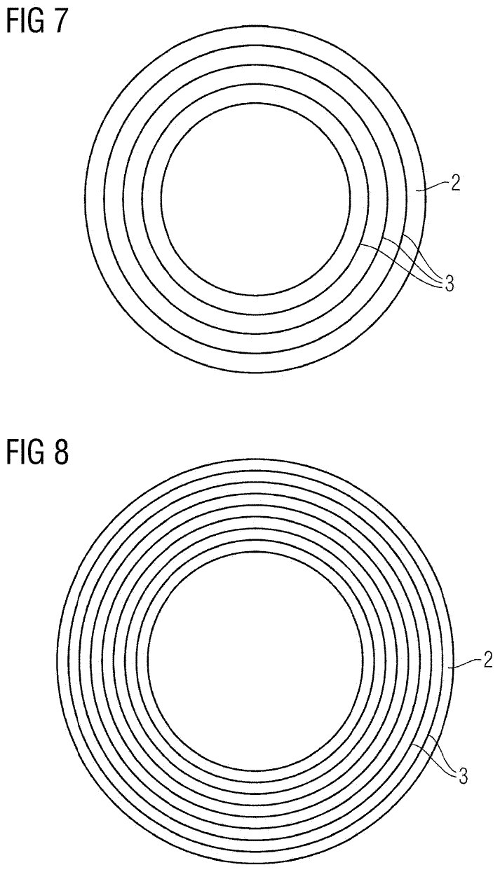

FIG. 1A to FIG. 9 show, by way of example, embodiments for a magnetic core of a stator of an electrical machine. The same principle may analogously be applied to the rotor of an electrical machine, to transformers, or generally to any type of electromechanical energy transducer. The figures illustrate magnetic steel laminates 2 in the form of circular rings with slots 3 configured and arranged according to the present embodiments. The slots 3 are free of electrically conductive materials (e.g., are filled with air or a solid insulation material).

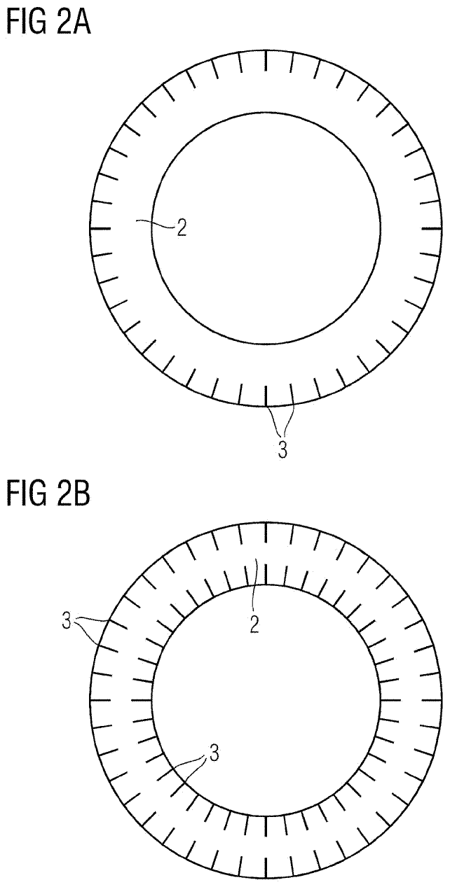

FIG. 1A, FIG. 1B, FIG. 2A, and FIG. 2B show radial slots 3 in different numbers and with different depths. FIG. 1A and FIG. 1B have slots 3 in a magnetic steel laminate 2 that run radially from the inside to the outside. FIG. 2A has slots 3 in a magnetic steel laminate 2 that run radially from the outside to the inside. FIG. 2B has slots 3 in a magnetic steel laminate 2 that run radially from the outside to the inside and radially from the inside to the outside.

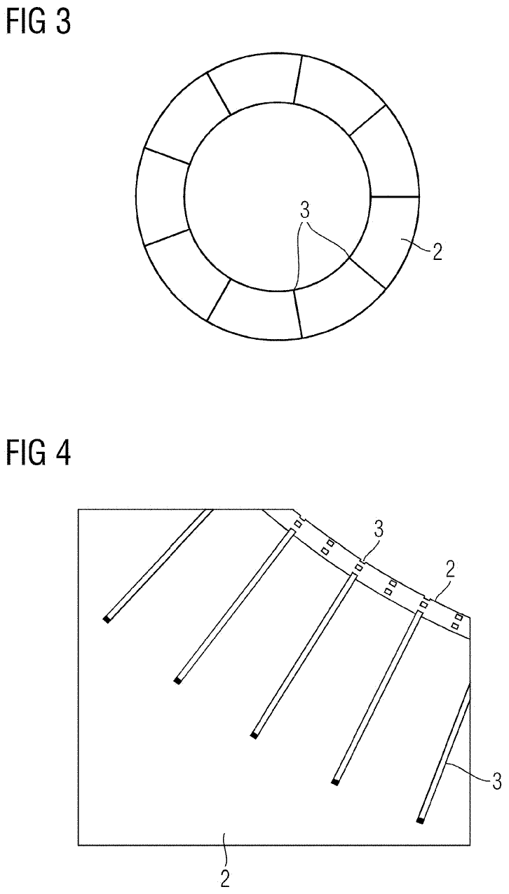

FIG. 3 shows slots 3 that completely cut through the circular ring. FIG. 4 shows a plurality of stacked magnetic steel laminates 2, where these are rotated in relation to one another such a way that slots 3 of adjacent layers do not lie one above the other.

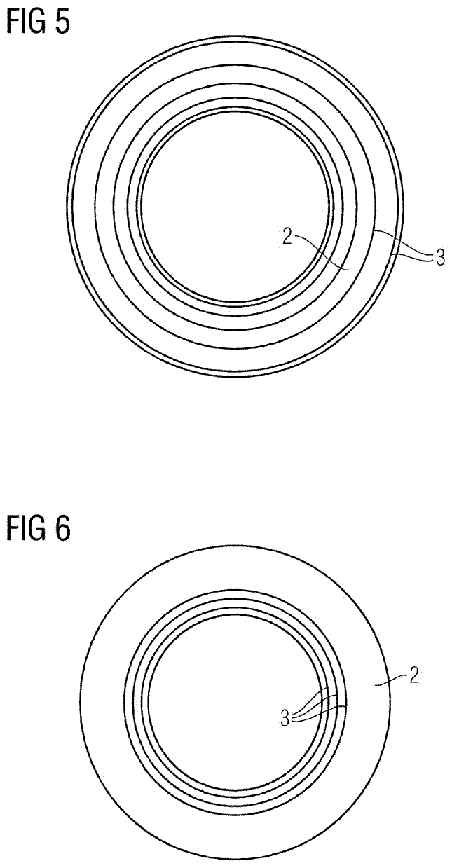

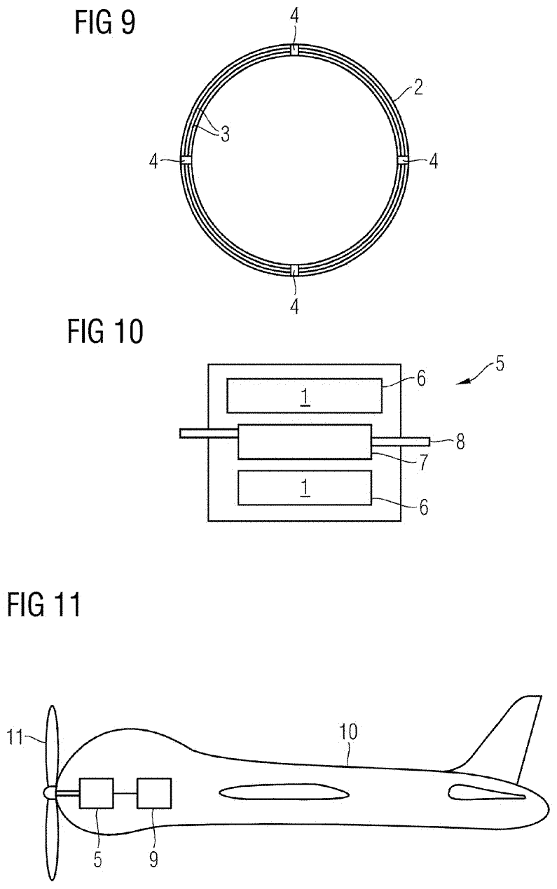

FIG. 5 to FIG. 9 show slots 3 that are formed tangentially or in the circumferential direction in different numbers and with different spacings. FIG. 9 also shows webs 4 that are intended to prevent the magnetic steel laminate 2 from falling apart in the case of continuous slots 3 and therefore hold the magnetic steel laminate 2 together.

The effectiveness of the slots 3 was checked based on numerical calculations on a superconducting generator with an air-gap winding that is distinguished by particularly markedly pronounced leakage fields in the region of the end faces of the stator magnetic core. The resistive losses caused by eddy currents in the outer magnetic steel laminate 3 of the magnetic core may be reduced by at least 50% by making only two continuous tangential slots 3.

However, owing to a deliberate arrangement of webs 4 in accordance with FIG. 9, the resistive losses increase only by approximately 10%. Therefore, the resistive losses in the outer magnetic steel laminate 2 of a stator may be more than halved, while at the same time, providing mechanical fixing of the magnetic steel laminates by making only two tangential slots 3. Increasing the number of slots has the potential to further reduce the losses. Studies of an equivalent topology of the magnetic core with radial slots have likewise demonstrated the positive effect of forming slots. In one embodiment, it is possible to reduce the original losses of a non-slotted magnetic steel laminate by almost two thirds.

FIG. 10 shows a block diagram of an electrical machine 5 including a rotor 7 that drives a shaft 8, and a stator 5 with a magnetic core 1 that has stacked magnetic steel laminates that are electrically insulated from one another in accordance with FIG. 1 to FIG. 9.

FIG. 11 shows an electric or hybrid-electric aircraft 10 (e.g., an airplane) including a power converter 9 that supplies an electrical machine 5 with electrical energy. The electrical machine 5 drives a propeller 11. Both are part of an electrical thrust generating unit.

Although the invention has been described and illustrated more specifically in detail using the exemplary embodiments, the invention is not restricted by the disclosed examples, and other variations may be derived therefrom by a person skilled in the art without departing from the scope of protection of the invention.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A magnetic core for an electromagnetic transducer, the magnetic core comprising:
magnetic steel laminates that are stacked in layers; and
at least one slot that is formed in at least one of the magnetic steel laminates,
wherein the at least one slot is free of electrically conductive material.

2. The magnetic core of claim 1, wherein the at least one slot is filled with air, an electrically insulating material, or air and the electrically insulating material.

3. The magnetic core of claim 1, wherein the at least one slot includes slots arranged offset in relation to one another in different layers.

4. The magnetic core of claims 1, wherein the magnetic steel laminates are in the form of a circular ring.

5. The magnetic core of claim 4, wherein the at least one slot is formed in a radial direction.

6. The magnetic core of claim 5, wherein the at least one slot cuts through the magnetic steel laminate in the radial direction.

7. The magnetic core of claim 4, wherein the at least one slot is formed in a circumferential direction.

8. The magnetic core of claim 7, wherein the at least one slot cuts through the magnetic steel laminate in the circumferential direction.

9. The magnetic core of claim 7, further comprising at least one web that is formed in the magnetic steel laminate, the at least one web being free of the at least one slot.

10. A stator of a rotatable electrical machine, the stator comprising:
a magnetic core for an electromagnetic transducer, the magnetic core comprising:
magnetic steel laminates that are stacked in layers; and
at least one slot that is formed in at least one of the magnetic steel laminates,
wherein the at least one slot is free of electrically conductive material.

11. The stator of claim 10, wherein the at least one slot is filled with air, an electrically insulating material, or air and the electrically insulating material.

12. The stator of claim 10, wherein the at least one slot includes slots arranged offset in relation to one another in different layers.

13. The stator of claims 10, wherein the magnetic steel laminates are in the form of a circular ring.

14. The stator of claim 13, wherein the at least one slot is formed in a radial direction.

15. A rotatable electrical machine comprising:
a stator comprising:
a magnetic core for an electromagnetic transducer, the magnetic core comprising:
magnetic steel laminates that are stacked in layers; and
at least one slot that is formed in at least one of the magnetic steel laminates,
wherein the at least one slot is free of electrically conductive material.

16. A vehicle comprising:
a rotatable electrical machine for an electric or hybrid-electric drive, the rotatable machine comprising:
a stator comprising:
a magnetic core for an electromagnetic transducer, the magnetic core comprising:
magnetic steel laminates that are stacked in layers; and
at least one slot that is formed in at least one of the magnetic steel laminates,
wherein the at least one slot is free of electrically conductive material.

17. The vehicle of claim 16, wherein the vehicle is an aircraft.

18. The vehicle of claim 17, further comprising:
a power converter that supplies the rotatable electrical machine; and
a propeller that is settable in rotation by the rotatable electrical machine.
